(19) United States
(12) Patent Application Publication
(10) Pub. No.: US 2006/0224364 A1
(43) Pub. Date: Oct. 5, 2006

(54) Instruments

(75) Inventors: John Paul Ronaldson, Cumbria (GB); John Adrian Lightfoot, Cumbria (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: BIL Solutions Limited

(21) Appl. No.: 11/395,056

(22) Filed: Mar. 31, 2006

(30) Foreign Application Priority Data
Mar. 31, 2005 (GB) 0506522.2

(51) Int. Cl. G06F 15/00

(52) U.S. Cl. 702/189; 702/8

(57) ABSTRACT

A method and data processing system for monitoring radioactive emissions includes providing a processor, the processor having a plurality of potential data input channels, providing data input to the processor through two or more of the potential data input channels, that data input being generated by an instrument, combining all the two or more data inputs in the processor, the processor being capable of handling data input from at least two of each of the following groups: (i) a gamma detector, a low resolution gamma detector, a high resolution gamma detector, a beta detector, an alpha detector, an ion detector, an X-ray detector, a neutron detector, a detectors responding to passive emissions, a detector responsive to active emissions, a detector responsive to a transmission source; and (ii) a distance measurer, such as a range finder, a visual radiation detector, such as a still camera and/or digital camera and/or video camera, a measurer of weight, a measurer of mass, a measurer of size; the method further outputting information based upon combining all the data inputs.

### CROSS-REFERENCE TO RELATED APPLICATIONS

This application claims priority to United Kingdom Patent Application No. GB 0506522.2, filed Mar. 31, 2005, the disclosure of which is incorporated herein by reference.

### BACKGROUND OF THE INVENTION

1. The Field of the Invention

The present invention concerns improvements in and relating to the design, construction and evaluation of apparatus and methods for investigating situations, particularly, but not exclusively emissions from radioactive materials, as well as with apparatus and methods for investigating situations, particularly, but not exclusively emissions from radioactive materials.

2. The Relevant Technology

Existing design processes for radiometric instruments and existing radiometric instruments generally take the form of a specific design brief. This will include details of set data inputs, set data input formats, set processing approaches and set presentations of the results.

### SUMMARY OF THE INVENTION

The present invention has amongst its potential aims to provide an improved design process and/or design evaluation process and/or designs which are more versatile and/or more flexible and/or more cost effective to pursue.

According to a first aspect of the invention we provide a method of monitoring radioactive emissions, the method comprising:

providing a processor, the processor having a plurality of potential data input channels;

providing data input to the processor through two or more of the potential data input channels, the data being generated by an instrument;

combining the two or more data inputs in the processor;

outputting information based upon the combined data inputs.

The processor may be provided with one or more operators for combining the two or more data inputs. The operators may be algorithms and/or software and/or hardware. The operators may be held in the processor and/or may be obtained by the processor from a store as needed.

The data input channels which receive data inputs may be unknown prior to the receipt of data inputs. The data input channels which receive data inputs are preferably not pre-determined. The data input channels which receive data inputs may change between one monitoring occasion and another and/or between one systems operation of the method and another systems operation of the method. Preferably the processor receives data inputs from a number of channels which is unknown prior to receipt of data inputs.

The data inputs may include data generated by one or more of radiometric instruments. The data inputs may be generated by one or more instruments using one or more detector types. The data inputs may include data generated by a gamma detector, low resolution gamma detector, high resolution gamma detector, beta detector, alpha detector, ion detector, X-ray detector, neutron detector. The data inputs may include data generated by detectors responding to passive emissions and/or active emissions and/or transmission sources. The data inputs may include data generated by a collimated or shielded detector.

The data inputs may include data generated by tomography, including one or more of emission tomography or transmission tomography.

The data inputs may include data generated by a distance measurer, such as a range finder. The data inputs may include data generated by a visual radiation detector, such as a still camera and/or digital camera and/or video camera.

The data inputs may include data generated by measuring weight and/or mass and/or size.

The data inputs may include data concerned with activity and/or dose and/or geometry of an environment.

The data may be generated during the use of the method. The data may be generated in advance of the use of the method. The data may be stored before use in the method. The data may be historic data.

Preferably the combining of the two or more data inputs is reviewed and/or iterated and/or refined, preferably to give outputted data which has the greatest certainty and/or least error and/or highest probability. The combining of the two or more data inputs may be provided to give the best outputted data.

Preferably the combining of the two or more data inputs gives output data which uses all the available data inputs. Preferably the combining of the two or more data inputs uses redundancy to generate the outputted data.

Preferably the method receives data from all the data input channels. Preferably the method provides outputted data whatever the number of input data channels data is received through.

The outputted data may be expressed in the form of one or more statements of the form: value X with probability Q and error R, where X, Q and R are quantities.

The combining may combine the data inputs in a weighted manner. The combining may be provided according to the form:

estimate of system=variable 1 factored by constant A . . . variable n factored by constant Aₙ

where n is any integer. The factor may be multiplication.

The outputted information may be one or more of, including such information in combined or overlain form, an activity distribution and/or dose rate map and/or indication of matrix correction and/or an indication of source distribution correction and/or a radiometric fingerprint and/or an indication of matrix correction.

According to a second aspect of the invention we provide a method of monitoring radioactive emissions, the method comprising:

providing a processor, the processor having a plurality of potential data input channels;

providing data input to the processor through two or more of the potential data input channels, the data being generated by an instrument;

combining the two or more data inputs in the processor so as to provide the best monitoring from the data inputs received;

outputting information based upon the combined data inputs.

The best monitoring may be monitoring with the greatest accuracy and/or greatest probability and/or least uncertainty. The monitoring may provide an indication of mass and/or activity.

The various aspects of the present invention may include any of the features, options or possibilities set out elsewhere in this application.

### BRIEF DESCRIPTION OF THE DRAWINGS Various embodiments of the invention will now be described, by way of example only, and with reference to the accompanying drawings in which:

FIG. 1 illustrates a prior art type instrument design and function;

FIG. 2 is a table of instruments and techniques concerned with activity distribution and matrix connection;

FIG. 3 is a schematic illustration of an instrument concept according to the present invention;

FIG. 4 is a schematic illustration of an instrument design process according to the present invention; and

FIG. 5 is another illustration of the approach of the present invention.

### DETAILED DESCRIPTION OF THE PREFERRED EMBODIMENTS

A wide variety of radiometric instruments are known. Instruments for investigating alpha, beta, gamma, neutron, X-ray and other emissions, singularly or in various combinations have been made. The approach taken to their design has generally been consistent, however.

The design process starts with a problem; a situation which requires investigation. The situation will generally define the nature of the environment the investigation is to take place in. This may be a room containing emission sources, for instance. This provides a design requirement for the instrument to be suitable for deployment in that environment. The situation may provide certain historical information on the emission source present. Hence one or more isotopic components of the emission source may be known and this may determine the best type of emissions to use to investigate the situation. Hence a design requirement to use a detector suitable for a certain purpose is provided. Further information may be known about the situation, such as the distribution of the emission sources within the environment being unknown. There is thus a design requirement that the instrument be capable of investigating different parts of the environment effectively. Furthermore, the information which needs to be established and the degree of precision required sets another design requirement.

Based on the various design requirements, an instrument may exist which satisfies them or alternatively a new instrument needs to be designed. To a large extent any new instrument is specific to the solution of those design requirements. It takes the form of specific hardware, and software to gather, process and present the necessary data. In use, the predetermined and expected data form is collected, worked upon in predetermined way and produces a predetermined form of output.

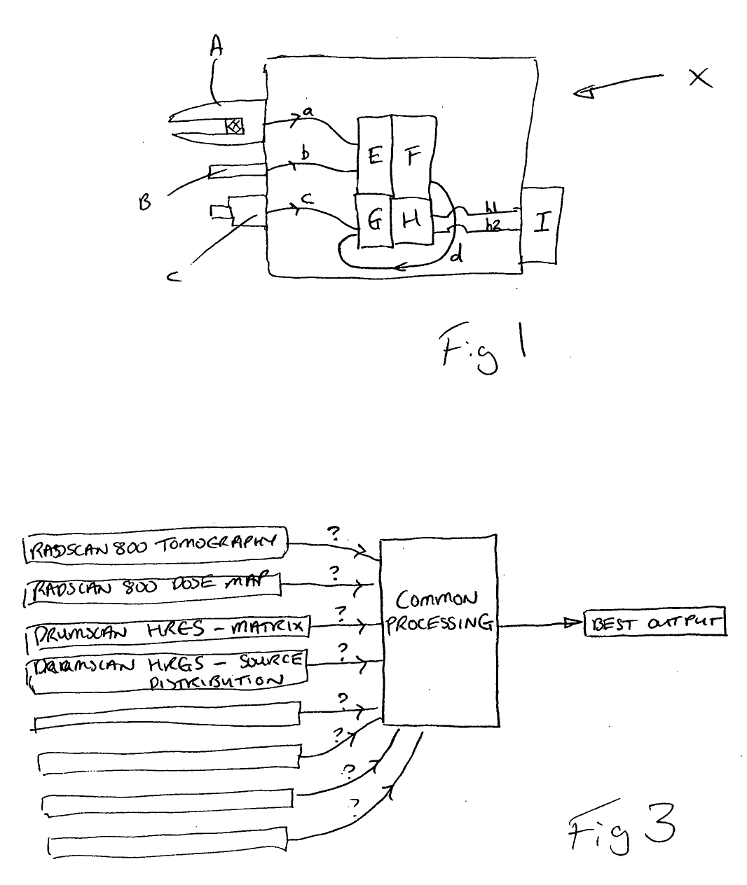

The structure resulting is shown schematically in FIG. 1. Basically, input data is received from a known, fixed, number of origins, for instance: gamma detector, A; range finder, B; video camera, C which are provided on the instrument X. The data format for each of the known number of input data origins is known and expected. In some cases, the input data, a, from one origin, the gamma detector A, is used together with the input data, b, from another, the range finder B, to give an output data, d. The output data, d, arises as a result of processing using fixed hardware E operating fixed software F. Output data, d, and input data c, may be further processed using fixed hardware G operating fixed software H to enable output data, g1, to be displayed as an overlay for output data g2. The instrument from its conception through to its use is in this known fixed format.

If a similar situation arises again, then the instrument may be used there. If a significantly different set of design requirements arise then the design approach starts again in a similar way, but with a different bespoke instrument arising.

The design approach of the present invention uses the fact that a wide variety of techniques exist or can be developed which seek to provide information on one or more of the general issues involved in an investigation.

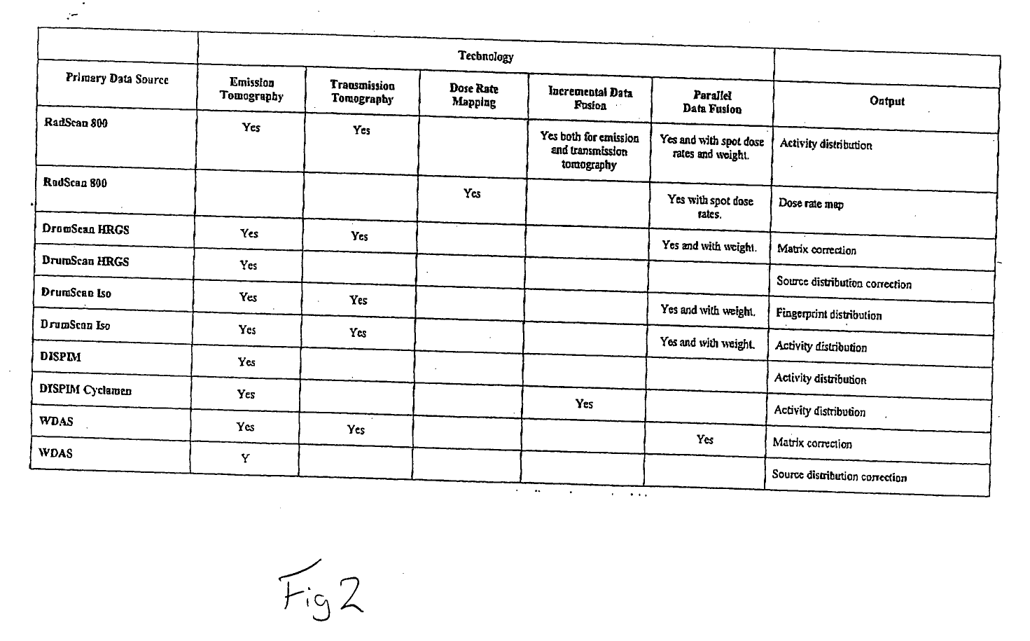

To take a specific example, illustrated in the table of FIG. 2, a number of techniques are provided which seek to provide information on the general issue of matrix absorber properties, for instance in a drum of radioactive waste. The techniques may explore that general issue in terms of a factor related to matrix density or another indicator of matrix absorber properties. The matrix is the material alongside the emission sources in the drum containing the radioactive material under investigation. The matrix is significant as it has an impact on the attenuation of the emissions from the source and/or shielding of the source relative to the detector.

In the same table of FIG. 2, a number of other techniques are provided which seek to provide information on the source emissions. The source emissions are significant in providing information on the type and level of emissions and hence the sources.

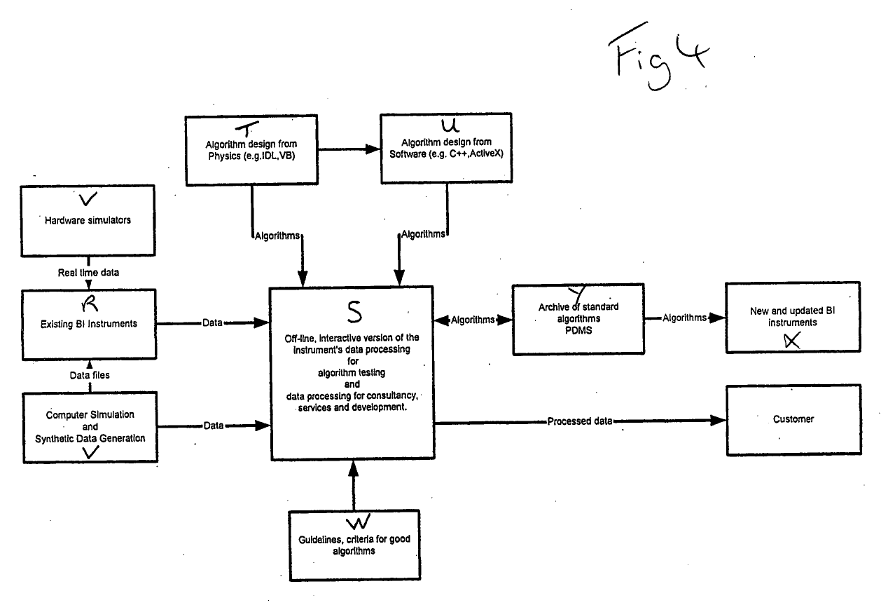

Under the prior art approach, an instrument design would have involved a fixed selection of a technique. The present invention, schematically illustrated in FIG. 3, provides a common processing approach through a core function, COMMON PROCESSING, which is designed to be able it to accept and process data from a wide variety of techniques, without necessarily having prior knowledge that any one of the given techniques will be contributing data and without a requirement that it must do so for the COMMON PROCESSING to provide a solution. The common processing approach allows useful output data from a more flexible arrangement of input data origins and forms.

A number of advantages stem from this ability.

Firstly, it enables existing data from a variety of existing instruments to be combined and provide new output data. This is true for instruments which were not designed originally to operate together or have their data combined. The approach can operate successfully faced with a variety of different data situations.

Secondly, it is possible to combine a variety of different data types together, which were not previously envisaged for combination, so as to give more complete output data or complementary output data which is greater than that available from the consideration of the data types separately.

Thirdly, the common processing approach means that a common core to future instruments can be provided which avoids the need for more expensive, less versatile bespoke cores to be provided for instruments. The common processing approach may use a common software/algorithm approach in all cases, or may be capable of receiving one or more of a number of software/algorithm forms. The approach may include a library of software/algorithm forms which are developed for the common processing approach. The form used may depend upon the specifics of the situation being considered and/or the input sources available.

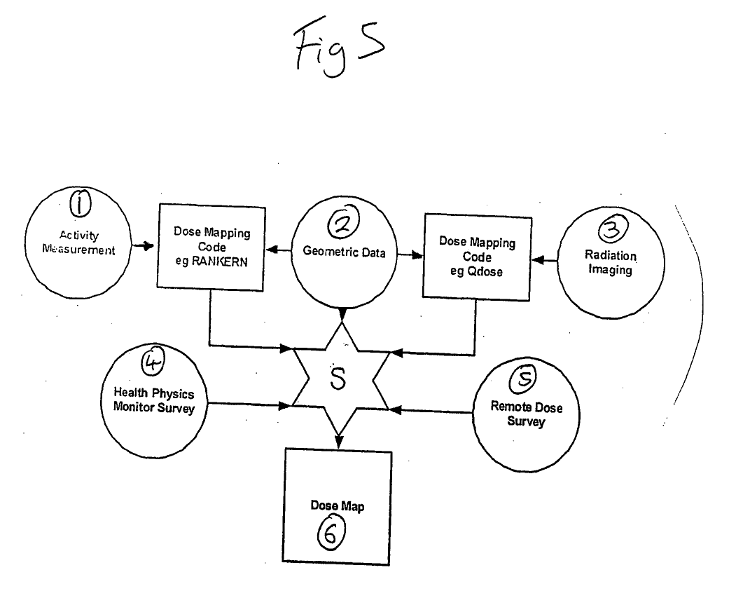

As well as benefits in terms of the approach to a particular instrument that arises and/or a particular situation being investigated, the invention allows a fundamentally different approach to the design process to be taken. The new approach is illustrated in FIG. 4, schematically.

Rather than requiring the building and testing of a particular new instrument, a lot of valuable information can be obtained through the use of the common processing approach. This allows existing instruments, R, to feed data to the common processing approach, S, and consider them using potentially new algorithms etc from a design stage. The design stage could be a physics design stage, T, where new approaches are being advanced and/or a software design stage, U, where new approaches are being advanced. The common processing approach S can also receive data from simulators and/or synthetic data generators, V. The common processing approach can also receive other inputs, such as guidelines on accuracy or the like for a particular situation, W. The benefits/problems of all these new designs and guidelines can be considered easily using the common processing approach. Furthermore, this can be done using a variety of data forms and origins. The use of real data and/or instruments readily allows a comparison of the new design approach to the output from the old approach. The result is new or updated instruments X and/or an updated common processing approach S and/or more algorithms and the like for the archive Y.

The process can be used to provide new instrument configurations quickly and cost effectively with more security of knowledge on their subsequent performance. The possibility of trialing in detail far more “what if” projects arises; simulation and evaluation without the need for formal construction of the instrument are rendered possible. Additionally, the ability to modify with time and improve the interface between the physics and software aspects is increased. The use of a common library of algorithms increases consistency of approach and rigour of testing over time. The process can also be used to establish and increase a library of useful algorithms. These and the other benefits of this design approach provide a substantial tool kit of approaches and forms for use in consultancy work.

Another illustration of the operation of the approach of the present invention is provided in FIG. 5. Here data type 1, an activity measurement, is used as one input for first dose mapping code (such as RANKERN). Data type 2, geometric data about the environment provides the other input. This geometric information, data type 2, is also fed to another dose mapping code (such as Qdose) together with radiation imaging information, data type 3. The outputs from the dose mapping code and the geometric data are fed to the common processing approach S. Data type 4 from a health physics survey instrument and data type 5 from a remote dose survey instrument are also fed to the common processing approach, S. The overall output of the common processing approach, S, is the dose map 6. This is a significantly improved dose map compared with that obtained from the dose mapping codes individually, the prior art approach.

The common processing function can work in a variety of ways.

It is for instance possible to receive data through a channel for a specific instrument or detector type and provide conversion of that input into a form suitable for use by the common processing through the use of specific conversion hardware and/or software and/or algorithms for that channel. This approach may be useful with existing instruments which need to be integrated, but for which their output form is already set.

After such an approach, or without it and working on the raw inputs, it is possible to combine the different inputs in a number of ways.

One approach is to take a probabilistic approach on the basis that the system will receive information on the instruments observations, through the inputs, and that these can be used together with knowledge of prior probabilities on various factors. A Bayesian approach can be taken in such a case and Bayesian networks can potentially be used to detail the conditionality of situations to one another.

Solution of the combination through the use of Kalman filters or extended Kalman filters can also be used. Such an approach takes a measurement of a system at a point in time, adjusts it to reflect an advance in time and projection of the system at that time before completing the loop through a measurement of the system at that advanced time. Repeating the cycle describes the state of the system and continually updates it. The approach uses constants in the filter and these are updated to reduce the different between the projected and the actual measurements of the system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of monitoring radioactive emissions, the method comprising:
providing a processor, the processor having a plurality of potential data input channels;
providing data input to the processor through two or more of the potential data input channels, that data input being generated by an instrument; and
combining all the two or more data inputs in the processor, the processor being capable of handling data input from at least two of each of the following groups
i) a gamma detector, a low resolution gamma detector, a high resolution gamma detector, a beta detector, an alpha detector, an ion detector, an X-ray detector, a neutron detector, a detectors responding to passive emissions, a detector responsive to active emissions, a detector responsive to a transmission source; and
ii) a distance measurer, such as a range finder, a visual radiation detector, such as a still camera and/or digital camera and/or video camera, a measurer of weight, a measurer of mass, a measurer of size; and outputting information based upon combining all the data inputs.

2. The method according to claim 1 in which the processor is capable of handling data input from at least three of group i).

3. The method according to claim 1 in which the processor is capable of handling data input from at least four of group i).

4. The method according to claim 1 in which the processor is capable of handling data input from at least three of group ii).

5. The method of monitoring radioactive emissions, the method comprising:
providing a processor, the processor having a plurality of potential data input channels;
providing data input to the processor through two or more of the potential data input channels, the data being generated by an instrument;
combining the two or more data inputs in the processor; and
outputting information based upon the combined data inputs.

6. The method according to claim 5 in which the method provides outputted data whatever the number of input data channels data is received through.

7. The method according to claim 5 in which the data input channels which receive data inputs are unknown prior to the receipt of data inputs.

8. The method according to claim 5 in which the data input channels which receive data inputs are not pre-determined.

9. The method according to claim 5 in which the processor is provided with one or more operators for combining the two or more data inputs.

10. The method according to claim 9 in which the operators are held in the processor and/or are obtained by the processor from a store as needed.

11. The method according to claim 5 in which the combining of the two or more data inputs is reviewed and refined to give outputted data which has the greatest certainty.

12. The method according to claim 5 in which the combining combines the data inputs in a weighted manner.

13. The data processing system for monitoring radioactive emissions, the data processing system comprising:
a processor, the processor having a plurality of potential data input channels, the processor being adapted to receive data input through two or more of the potential data input channels, that data input being generated by an instrument, the processor being adapted to combining all the two or more data inputs in the processor, the processor being adapted to handle data input from at least two of each of the following groups:
i) a gamma detector, a low resolution gamma detector, a high resolution gamma detector, a beta detector, an alpha detector, an ion detector, an X-ray detector, a neutron detector, a detectors responding to passive emissions, a detector responsive to active emissions, a detector responsive to a transmission source; and
ii) a distance measurer, such as a range finder, a visual radiation detector, such as a still camera and/or digital camera and/or video camera, a measurer of weight, a measurer of mass, a measurer of size;
the processor being adapted to output information based upon combining all the data inputs.

14. The data processing system for monitoring radioactive emissions, the data processing system comprising:
a processor, the processor having a plurality of potential data input channels, the processor being adapted to receive data input to the processor through two or more of the potential data input channels, the data being generated by an instrument, the data processor being adapted to combine the two or more data inputs in the processor, the processor being adapted to output information based upon the combined data inputs.
